(19) United States
(12) Patent Application Publication
(10) Pub. No.: US 2025/0086653 A1
(43) Pub. Date: Mar. 13, 2025

(54) TRACKING AND VERIFICATION OF SUSTAINABILITY DATA

(71) Applicant: The Toronto-Dominion Bank, Toronto (CA)

(72) Inventors: Milos DUNJIC, Oakville (CA); David Samuel TAX, Toronto (CA); Jonathan Joseph PRENDERGAST; Hitesh BAJAJ; Pranay Chander GUPTA, Toronto (CA); Alexander Stuart MORRIS, Toronto (CA)

(73) Assignee: The Toronto-Dominion Bank, Toronto (CA)

(21) Appl. No.: 18/463,835

(22) Filed: Sep. 8, 2023

(51) Int. Cl. G06Q 30/018

(52) U.S. Cl. CPC G06Q 30/018

(57) ABSTRACT

Systems and methods for tracking and verifying sustainability data are provided. A system may receive a first transfer request message associated with a conveyance of a first item from a first entity to a second entity. The message may include first sustainability data associated with the first item, which may be a production input of a second item. The system may then obtain second item composite sustainability data to be included in a second transfer request message associated with a conveyance of the second item from the second entity to a third entity. The system may then verify the second item composite sustainability data by determining that this data includes at least a portion of the first sustainability data and second item production sustainability data. The system may then send the second transfer request message. The second transfer request message may include the second item composite sustainability data.

### TECHNICAL FIELD

The present application relates to sustainability data, such as Environmental, Social, and Governance (ESG) data, and more particularly to tracking and verifying ESG data and providing the ESG data to end users.

### BACKGROUND

In recent years, there has been an increasing interest by organizations and individuals in sustainability—to giving preference to suppliers that generate positive social and environmental outcomes. Organizations and individuals have become increasingly interested in looking at what products are made of, where they have come from, who has made them, and how they will be ultimately disposed.

At present, it can be challenging to determine the sustainability associated with various products. For example, it can be challenging to determine the carbon footprint of a particular product. All of the various inputs of a product have a contributing effect on the overall carbon footprint of the product, and not all manufacturers may provide sustainability data. Furthermore, even when a manufacturer does provide sustainability data, there may be an absence of reliable means to verify the accuracy of such data.

Improvements to the field are desired.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level operation diagram of an example computing device;

FIG. 3 depicts an example simplified software organization of the example computing device of FIG. 2;

FIG. 4 is a flowchart showing operations for sending a second transfer request message including second item composite sustainability data, in accordance with embodiments of the present disclosure;

FIG. 5 is a is a first schematic illustration in accordance with embodiments of the present disclosure;

FIG. 6 is a second schematic illustration in accordance with embodiments of the present disclosure;

FIG. 7 is a flowchart showing operations for providing, to a client device, the second item composite sustainability data, in accordance with embodiments of the present disclosure;

FIG. 8 shows an example display screen of an example user interface presented on a client device 140, in accordance with embodiments of the present disclosure; and

FIG. 9 is a flowchart showing operations for denying a transfer request, in accordance with embodiments of the present disclosure.

Like reference numerals are used in the drawings to denote like elements and features.

### DETAILED DESCRIPTION OF VARIOUS EMBODIMENTS

In order to provide sustainability data in connection with a product, systems and methods are provided to track, maintain, verify and provide sustainability data associated with production inputs, manufacturing and shipping, for example. Sustainability data may include Environmental, Social, and Governance (ESG) data. ESG data may provide information about the environmental, social, and governance attributes of a vendor and/or a particular product provided by the vendor. For example, environmental data may include data on energy usage, carbon emissions, (e.g., carbon footprint data), water usage, and waste management practices associated with a vendor and/or a product. Social data may include data on labour practices, human rights policies, community engagement, and diversity and inclusion initiatives (e.g., a percentage of women and/or minority ownership, an indication of the diversity of a corporate board or other governance structure, etc.), associated with a vendor and/or a product. Governance data may include data on corporate board composition, executive pay, and anti-corruption policies associated with a vendor and/or a product.

System and methods described herein may provide for the inclusion of ESG data in transfer request messages and/or with associating ESG data with transfer request messages. In this way, ESG data may be tracked, maintained, verified and provided to entities.

As noted, ESG data may include, for example, carbon footprint data and social data. By way of example, ESG data may include an indication of whether an entity initiating a transfer request is minority-owned, women-owned, etc. In at least some implementations, ESG data may indicate a percentage of minority or women ownership; for example, the ESG data may indicate that an entity initiating a transfer request is 55% woman owned. In some implementations, the ESG data may include an indication of the diversity of a corporate board or other governance structure associated with the entity initiating the transfer request. By way of example, the ESG data may indicate that a corporate board includes 50% women.

ESG data may be included as metadata in a transfer request message. For example, ESG data may be included in one or more fields of an ISO 20022 message.

In accordance with one aspect of the present disclosure, there is provided a computer system comprising a processor and a memory coupled to the processor The memory stores instructions that, when executed by the processor, cause the computer system to: receive a first transfer request message associated with a conveyance of a first item from a first entity to a second entity, the first transfer request message including first sustainability data associated with the first item, the first item being a production input of a second item; obtain second item composite sustainability data, the second item composite sustainability data to be included in a second transfer request message associated with a conveyance of the second item from the second entity to a third entity; verify the second item composite sustainability data by determining that the second item composite sustainability data includes at least a portion of the first sustainability data and second item production sustainability data; and send the second transfer request message, the second transfer request message including the second item composite sustainability data.

In some implementations, prior to sending the second transfer request message, the computer system is further caused to determine a trust score associated with the second item composite sustainability data. The trust score is based on the verification of the second item composite sustainability data, and the second transfer request message further includes the trust score.

In some implementations, the computer system is further caused to provide, to a client device associated with the third entity, user interface data causing the client device to display a user interface that provides for an initiation of the sending of a response to the second transfer request message; determine that the trust score is greater than a threshold amount; and provide, to the client device, the second item composite sustainability data.

In some implementations, the first sustainability data includes a first quantifier associated with the first item, and the second item composite sustainability data includes a second quantifier associated with the second item.

In some implementations, verifying the second item composite sustainability data further causes the system to determine a production category associated with the second item, and verify that the second item composite sustainability data is within a reference range associated with the production category.

In some implementations, the conveyance of the first item from the first entity to the second entity includes transportation, and verifying the second item composite sustainability data includes determining that the second item composite sustainability data includes transportation sustainability data associated with the transportation.

In some implementations, obtaining the second item composite sustainability data includes providing, to a client device associated with the second entity, user interface data causing the client device to display a user interface that provides for input of the second item composite sustainability data.

In some implementations, the first transfer request message includes first metadata and the second transfer request message includes second metadata. The first metadata includes the first sustainability data and the second metadata includes second item composite sustainability data.

In some implementations, prior to verifying the second item composite sustainability data, the computer system is further caused to identify a third transfer request message associated with a conveyance of a third item from a fourth entity to the second entity, the third transfer request message including third sustainability data associated with the third item, the third item being a further production input of the second item. Verifying the second item composite sustainability data further includes determining that the second item composite sustainability data includes at least a portion of the third sustainability data.

In some implementations, the computer system is further caused to receive a fourth transfer request message associated with a conveyance of a fourth item from a fifth entity to the second entity, the fourth transfer request message including a transfer request, determine whether sustainability data associated with the fourth item has been received, and in response to determining that sustainability data associated with the fourth item has not been received, deny the transfer request.

In some implementations, each of the first sustainability data, the second item production sustainability data, and the second item composite sustainability data include environmental, social, and governance (ESG) data.

In some implementations, the ESG data includes carbon footprint data.

In some implementations, the second item is associated with a product identifier, and the computer system is further caused to provide, to an e-commerce provider, via an application programming interface (API), the second item composite sustainability data and an indication of an association between the second item composite sustainability data and the product identifier.

In some implementations, the computer system is further caused to provide the second item composite sustainability data to an enterprise resource planning (ERP) system.

In accordance with another aspect of the present disclosure, there is provided a computer-implemented method comprising: receiving a first transfer request message associated with a conveyance of a first item from a first entity to a second entity, the first transfer request message including first sustainability data associated with the first item, the first item being a production input of a second item; obtaining second item composite sustainability data, the second item composite sustainability data to be included in a second transfer request message associated with a conveyance of the second item from the second entity to a third entity; verifying the second item composite sustainability data by determining that the second item composite sustainability data includes at least a portion of the first sustainability data and second item production sustainability data; and sending the second transfer request message, the second transfer request message including the second item composite sustainability data.

In some implementations, prior to sending the second transfer request message, the method further comprises determining a trust score associated with the second item composite sustainability data. The trust score is based on the verification of the second item composite sustainability data, and the second transfer request message further includes the trust score.

In some implementations, the method further comprises providing, to a client device associated with a third entity, user interface data causing the client device to display a user interface that provides for an initiation of the sending of a response to the second transfer request message; determining that the trust score is greater than a threshold amount; and providing, to the client device, the second item composite sustainability data.

In some implementations, the first sustainability data includes a first quantifier associated with the first item, and the second item composite sustainability data includes a second quantifier associated with the second item.

In some implementations, verifying the second item composite sustainability data includes determining a production category associated with the second item, and verifying that the second item composite sustainability data is within a reference range associated with the production category.

In accordance with yet another aspect of the present disclosure, there is provided a non-transitory computer-readable storage medium. The non-transitory computer-readable storage medium comprises processor-executable instructions which, when executed, configure a processor to: receive a first transfer request message associated with a conveyance of a first item from a first entity to a second entity, the first transfer request message including first sustainability data associated with the first item, the first item being a production input of a second item; obtain second item composite sustainability data, the second item composite sustainability data to be included in a second transfer request message associated with a conveyance of the second item from the second entity to a third entity; verify the second item composite sustainability data by determining that the second item composite sustainability data includes at least a portion of the first sustainability data and second item production sustainability data; and send the second transfer request message, the second transfer request message including the second item composite sustainability data.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

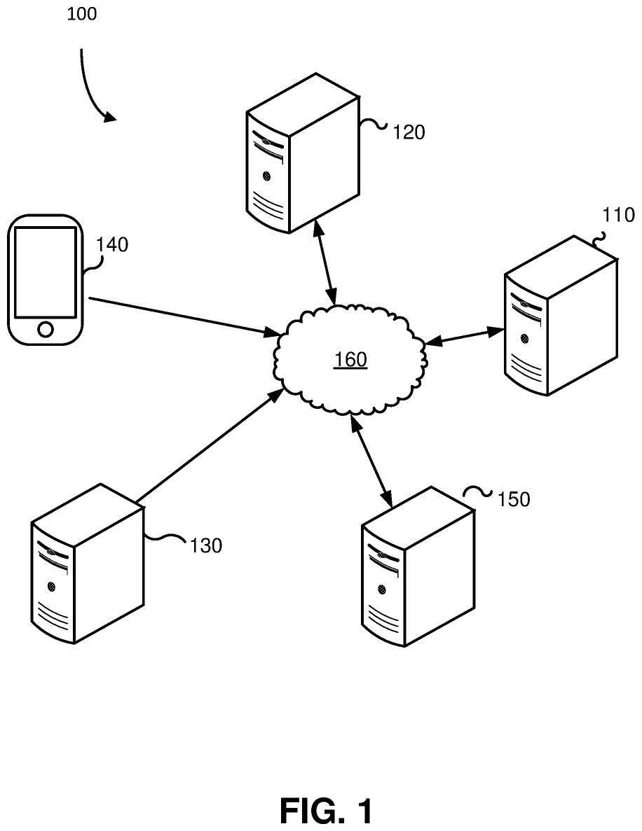

FIG. 1 is a schematic operation diagram illustrating an operating environment of an example embodiment.

As illustrated, the example operating environment 100 includes a first resource management system 110, a second resource management system 120, a transfer rail system 130, a third-party system 150, and a client device 140 in communication via a network 160.

System The first resource management system 110, the client device 140, the second resource management system 120, the third-party system 150, and the transfer rail system 130 are computer systems. Computer systems may be, for example, a mainframe computer, a minicomputer, or the like. Computer systems may include one or more computing devices. For example, a computer system may include multiple computing devices such as, for example, database servers, computer servers, and the like. The multiple computing devices may be in communication using a computer network. For example, computing devices may communicate using a local-area network (LAN). In some embodiments, computer systems may include multiple computing devices organized in a tiered arrangement. For example, a computer system may include middle-tier and back-end computing devices. In some embodiments, a computer system may be a cluster formed of a plurality of interoperating computing devices.

The first and second resource management systems 110, 120 may each be a single server, multiple servers, a server farm, or any other such arrangement of computing devices to implement computing server-like functionality. In some embodiments, the first and second resource management systems 110, 120 may track, manage, and maintain resources. The resources may, for example, be computer code, spreadsheet data, and/or database information and may include image, text, audio and/or video files. Additionally or alternatively, the resources may be computing resources, such as memory or processor cycles. Additionally or alternatively, the resources may be digital goods, such as digital media resources; fonts, logos, photos and graphics; digital subscriptions; online advertisements; internet coupons; electronic tickets; electronic documentation; downloadable software and/or mobile apps; cloud-based applications and online games; virtual goods used within the virtual economies of online games and communities; workbooks; worksheets; planners; e-learning (online courses); webinars, video tutorials; blog posts; cards; patterns; website themes; and/or templates. Examples of digital media resources include e-books, downloadable music, internet radio, internet television and/or streaming media. The resources may be a specific type of digital goods known as digital assets, and may include photography, logos, illustrations, animations, audiovisual media, presentations, spreadsheets, digital paintings, word documents, electronic mails, websites, and a multitude of other digital formats and their respective metadata. Digital assets may be subject to digital rights management (DRM) and/or digital asset management (DAM). By way of further example, the resources may be database resources, and may represent stored value, such as financial instruments, including fiat currency and cryptocurrency. In at least some implementations, the resources may be or include digital goods which are exchange mediums. For example, the digital goods may be or represent monetary instruments.

In some embodiments, the first and second resource management systems 110, 120 may track, manage, and maintain owned resources belonging to respective entities. The resources may be represented in a database, and the database may be provided in secure storage(s). The secure storage(s) may be provided internally within the first and second resource management systems 110, 120 or externally. The secure storage(s) may, for example, be provided remotely from the first and second resource management systems 110, 120. For example, the secure storage(s) may include one or more data centers. The data centers may, for example, store data with bank-grade security.

In some embodiments, the first and second resource management systems 110, 120 may include records for a plurality of resource accounts and at least some of the records may define a quantity of resources. A first entity may be associated with one or more accounts storing or otherwise reflecting owned resources, i.e., an owned resource account. The records may reflect a first quantity of stored resources that are associated with the first entity. Such resources may include owned resources. The amount of resources associated with the entity may be reflected by a resource definition defined in an associated resource record. The resource definition may be or include a balance defined in an associated record; for example a bank balance.

In some embodiments, the first and second resource management systems 110, 120 may be the same system.

As also shown in FIG. 1, the example operating environment 100 may include one or more transfer rail systems 130. The transfer rail system 130 may be a computing system that facilitates electronic transfer of financial resources and may, in at least some embodiments, be referred to as a payment rail system. By way of example, the transfer rail system 130 may be an electronic funds transfer (EFT) system, a wire transfer system, a real time rail transfer (RTR) system and/or an email money transfer (EMT) system. The transfer rail system 130 may be or include one or more of a Visa™, Mastercard™, American Express™, or other value transfer card (e.g., credit card) rail. The request to transfer resources may be a request to transfer data such as, for example, units of value. The units of value may include a quantity of currency. In some embodiments where the transfer rail system 130 is a computing system that facilitates electronic transfer of financial resources, the first and second resource management systems 110, 120 may be, for example, computer systems associated with one of more financial institutions, such as a bank.

In some embodiments, the client device may be used to request a computing operation, such as a resource transfer, to be facilitated by the transfer rail system 130. The resource transfer may, for example, involve a transfer of data, via the transfer rail system 130, between a first data record at the first resource management system 110 associated with a first account at the first resource management system 110 and a destination data record associated with a destination account at the second resource management system 120. The first resource account may belong to an entity operating the client device. The data involved in the resource transfer may, for example, be units of value and the records involved in the resource transfer may be adjusted in related or corresponding manners. For example, during a resource transfer, a record associated with an intended recipient (i.e., transferee) of the transfer may be adjusted to reflect an increase in value resulting from the transfer, whereas the record associated with the entity (i.e., transferor) initiating the transfer may be adjusted to reflect a decrease in value which is at least as large as the increase in value applied to the record associated with the recipient.

The client device 140 is also a computing device. In some embodiments, the client device 140 may, as illustrated, be a personal computer such as a smart phone. However, the client device 140 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In certain embodiments, the client device 140 may be associated with one or more users. The one or more users may be associated with an entity, such as a user or client, having resources associated with the first resource management system 110. In some implementations, a user may operate the client device 140 to cause the client device 140 to perform one or more operations consistent with the disclosed embodiments. In some embodiments, the client device 140 may include a smart card, chip card, integrated circuit card (ICC), and/or other card having an embedded integrated circuit.

In at least some embodiments, the third-party system 150 may be provided and the third-party system 150 may interact with other components as described herein. In some embodiments, the third-party system 150 may be configured to operate as an e-commerce server and may conduct transactions for goods and services over the Internet. In some embodiments, the third-party server may be configured to operate as an Enterprise, Resource, and Planning (ERP) system.

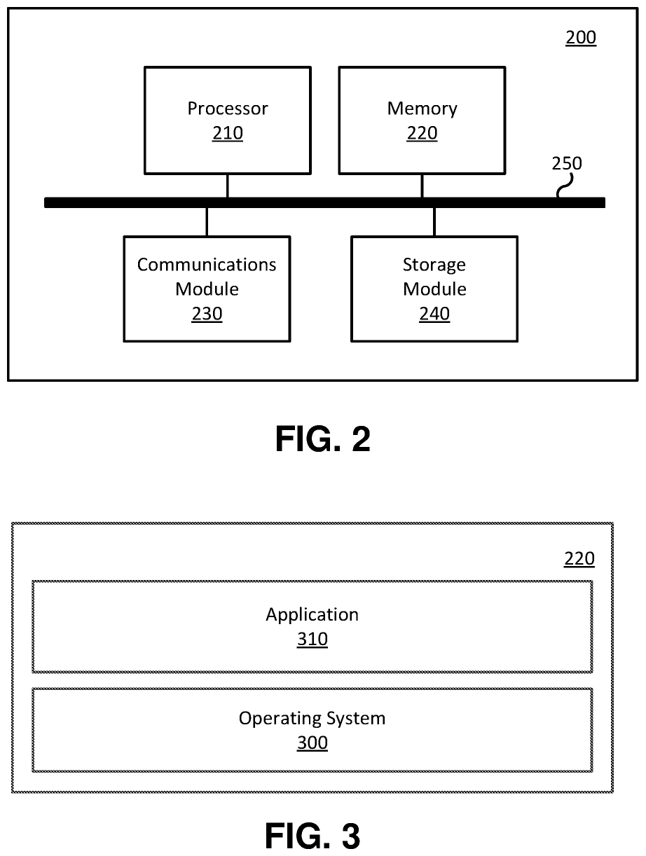

Referring now to FIG. 2, a high-level operation diagram of an example computing device 200 will now be described. The example computing device 200 may be exemplary of the first resource management system 110, the client device 140, the second resource management system 120, a third-party system 150, and/or the transfer rail system 130.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The example computing device 200 will include other components apart from those illustrated in FIG. 2 and the specific component set may differ based on whether the example computing device 200 is operating as the first resource account management system, the client device, the second resource account management system, and/or the transfer rail system. For example, the example computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the example computing device 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer device 200. As illustrated these software components include an operating system 300 and an application 310.

The operating system 300 is software. The operating system 300 allows the application 310 to access the processor 210, the memory 220, and the communications module 230. The operating system 300 may be, for example, UNIX™, Linux™, Microsoft™, Windows™. Apple™, Apple OSX™, Android™ or the like.

The application 310 adapts the example computing device 200, in combination with the operating system 300, to operate as a device to a particular function. For example, the application 310 may cooperate with the operating system 300 to adapt a suitable embodiment of the example computing device 200 to operate as the first resource account management system, the client device, the second resource account management system, the third-party system 150, and/or the transfer rail system.

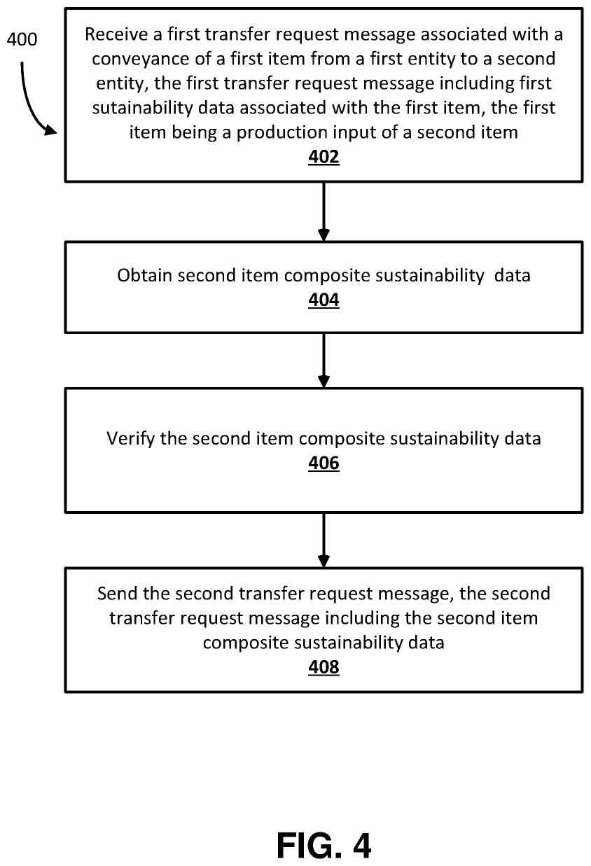

The operation of the first resource management system 110 (FIG. 1) will now be described with reference to the flowchart of FIG. 4 which illustrates a method 400 for sending a second transfer request message including second item composite sustainability data, in accordance with embodiments of the present disclosure. Operations 402 and onward are performed by one or more processors of a computing device, such as for example the processor 210 of a suitably configured instance of the example computing device 200, executing software such as, for example, a suitable instance of the application 310.

At the operation 402, the system receives a first transfer request message associated with a conveyance of a first item from a first entity to a second entity. The first transfer request message may include first item sustainability data associated with the first item, the first item being a production input of a second item.

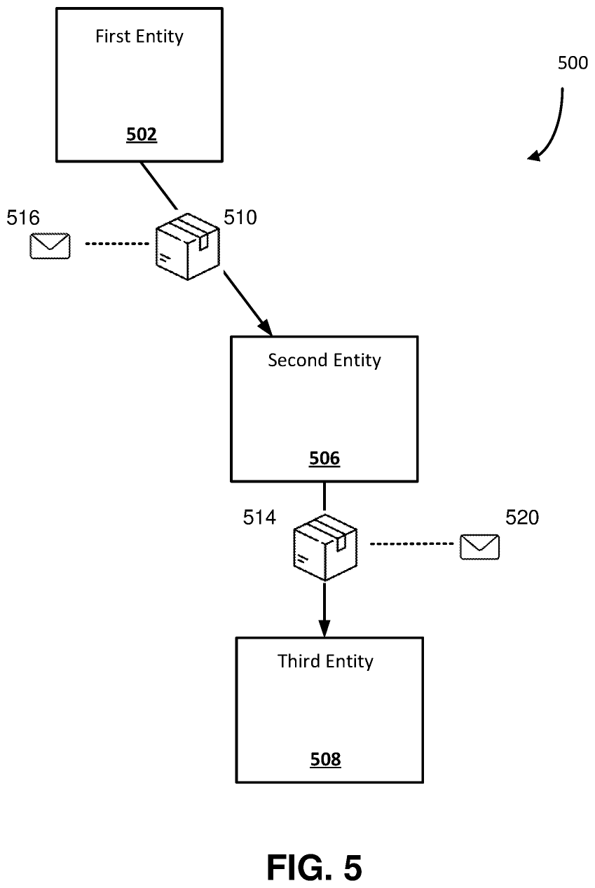

Reference is now made to FIG. 5, which is a first schematic illustration 500 in accordance with embodiments of the present disclosure. The first schematic illustration 500 illustrates the conveyance of first and second items 510, 520 between first, second, and third entities 502, 506, 508, as well as first and second transfer request messages 516, 520 associated with the conveyance of the first and second items 510, 520.

The first entity 502 may be a supplier of a first item 510 to the second entity 506. As shown, the first item 510 may be conveyed from the first entity 502 to the second entity 506. As further shown, a first transfer request message 516 may be associated with the conveyance of the first item 510 from the first entity 502 to the second entity 506. The first item 510 may be described with respect to a first quantity. At least a portion of the first item 510 may be a production input of the second item 514.

The second entity 506 may be a supplier of the second item 514 to the third entity 508. The second item 514 may be described with respect to a second quantity. In some embodiments, at least a portion of the first item 510 may be a production input of the second item 514. As shown, the second item 514 may be conveyed from the second entity 506 to the third entity 508. As further shown, a second transfer request message 520 may be associated with the conveyance of the second item 514 to the third entity 508. The third entity 508 may be, for example, a retailer or a consumer. In some embodiments, the first and second transfer request messages may be requests for compensation, such as, for example, payment request messages.

As a particular example, the first entity 502 may be a plastic manufacturer and the first item 510 may be a quantity of plastic. The second entity 506 may be a pen manufacturer and the second item 514 may be a quantity of pens. The third entity 508 may be a retailer or a consumer.

Returning again to FIG. 4, as noted, at the operation 402, the first transfer request message 516 (FIG. 5) may include first item sustainability data associated with the first item 510 (FIG. 5), the first item 510 (FIG. 5) being a production input of the second item 514 (FIG. 5).

By way of example, returning again to FIG. 5, the first item sustainability data may be or may include data representing a carbon footprint of the first item 510. The first item sustainability data may also include a first quantifier associated with the first item 510. The first quantifier may represent a first quantity, i.e., the quantity of the first item 510. In this way, the first transfer request message 516 may include data providing the carbon footprint per unit of the first item 510. The first transfer request message 516 may specify how the units are quantified.

In some examples, the first item sustainability data of the first transfer request message 516 may be or may include social or governance data instead of or in addition to carbon footprint data. By way of example, the first item sustainability data may indicate whether the first entity 502 is minority-owned, women-owned, etc. and/or may indicate a measure of management diversity.

In some examples, the first resource management system 110 (FIG. 1) may verify that the first item sustainability data is included in the first transfer request message 516 or is otherwise provided before otherwise provided before processing the first transfer request message 516. That is, the first item sustainability data may need to be provided by the first entity 502 as a precondition to receiving a response to the first transfer request message 516. If the first item sustainability data is not provided, then the first resource management system 110 (FIG. 1) may prevent a response to the first transfer request message 516. This practice may ensure that the first entity 502 provides the first item sustainability data.

Returning again to FIG. 4, after the operation 402, the operation 404 is next.

At the operation 404, the system obtains second item composite sustainability data. The second item composite sustainability data may be included in a second transfer request message associated with a conveyance of the second item from the second entity to a third entity.

The second item composite sustainability data may be obtained in a plurality of ways. Returning again to FIG. 5, in some examples, the second item composite sustainability data may be included in the second transfer request message 520. Additionally or alternately, the second item sustainability data may not be included in the second transfer request message 520 but may be provided in a manner that allows the second item composite sustainability data to be linked with or associated with the second transfer request message 520. For example, the second transfer request message 520 may include a link to an interface which allows for the input of the second item composite sustainability data. Additionally or alternatively, the second item composite sustainability data may be provided as part of a system such as an invoicing system and the second transfer request message 520 may then be linked to the second item composite sustainability data provided therein.

In some examples, obtaining the second item composite sustainability data may include providing, to a client device 140 (FIG. 1) associated with the second entity 506, user interface data causing the client device 140 (FIG. 1) to display a user interface that provides for input of the second item composite sustainability data.

In some embodiments, the second item 514 may be associated with a product identifier, such as a Stock Keeping Unit (SKU), a Universal Product Code (UPC), a European Article Number (EAN), etc. In some such embodiments, the product identifier may be obtained by the system in a manner similar to the manner in which the second item composite accountability data is obtained, i.e., as metadata in the second transfer request message 520, in a manner that allows the product identifier to be linked with or associated with the second transfer request message 520, and/or as part of a system such as an invoicing system which may then be linked to the second item composite sustainability data.

The second item sustainability data may also include a second quantifier associated with the second item 514. The second quantifier may represent a second quantity, i.e., the quantity of the second item 514. The second transfer request message may specify how the units are quantified. The second item composite sustainability data may be or may include data providing the carbon footprint per unit of the second item 514.

The second item composite sustainability data may include at least a portion of the first sustainability data. The second item composite sustainability data may also include second item production sustainability data.

As noted, the first item 510 may be a production input of the second item 514. As a result, at least a portion of the first item sustainability data may be applicable to the second item 514 and may form part of the second item composite sustainability data. For example, various inputs of the second item 514 may have a contributing effect on the overall carbon footprint of the second item 514. As a result, the second item composite sustainability data may include at least a portion of the first sustainability data.

The second item 514 may be further associated with second item production sustainability data. For example, a certain amount of carbon emissions may be created in connection with the production of the second item 514.

Returning to FIG. 4, after the operation 404, the operation 406 is next.

At the operation 406, the system verifies the second item composite sustainability data. The second item composite sustainability data may be verified by determining that the second item composite sustainability data includes at least a portion of the first sustainability data and second item production sustainability data.

Returning again to FIG. 5, for example, the first entity 502 may be a plastic manufacturer and the first item 510 may be a quantity of plastic. The second entity 506 may be a pen manufacturer and the second item 514 may be a quantity of pens. The second entity may receive, from the first entity, sustainability data associated with the first item 510 (e.g., the quantity of plastic). The second entity 506 may then use the sustainability data associated with the first item 510 to determine a portion of the second item composite sustainability data. In this way, the second item composite sustainability data may include at least a portion of the first sustainability data.

The system may verify the second item composite sustainability data by determining that the second item composite sustainability data includes at least a portion of the first sustainability data.

In addition to the at least a portion of the first sustainability data, there may be further sustainability data associated with the second item 514. For example, where the second entity 506 is a pen manufacturer and the second item 514 is a quantity of pens, there may be production sustainability data associated with the second item 514. The second item production sustainability data may include, for example, environmental data such as a carbon footprint associated with the production of a quantity of pens. As a further example, the second item production sustainability data may include social or governance data, such as an indication of whether the second entity 506 is minority of women-owned, and/or a measurement of management diversity, etc.

In some embodiments, verifying the second item composite sustainability data may include determining a production category associated with the second item 514 and verifying that the second item production sustainability data is within a reference range associated with the production category.

For example, the second item 514 may be a quantity of ballpoint pens, and a production category of ballpoint pens may be determined in association with the second item 514. A reference range may be associated with the production category of ballpoint pens. The reference range may represent customary ESG data values associated with the production of ballpoint pens. The reference ranges may be stored in a database, which may be internal or external to the first resource management system 110 (FIG. 1).

Accordingly, the system may further verify the second item composite sustainability data by determining that the second item composite sustainability data includes second item production sustainability data, and by further verifying that he second item production sustainability data is within a reference range associated with the production category.

In some embodiments, the conveyance of the first item 510 from the first entity 502 to the second entity 506 may include transportation. The transportation may be associated with transportation sustainability data. For example, a carbon footprint may be associated with the transportation. In some such embodiments, verifying the second item composite sustainability data may include determining that the second item composite sustainability data includes transportation sustainability data associated with the transportation.

In some embodiments, verifying the second item composite sustainability data may include determining that the second item composite sustainability data includes at least a portion of third sustainability data.

For example, the system may identify a third transfer request message associated with a conveyance of a third item from a fourth entity to the second entity 506 (FIG. 5). The third transfer request message may include third sustainability data associated with the third item, the third item being a further production input of the second item 514 (FIG. 4).

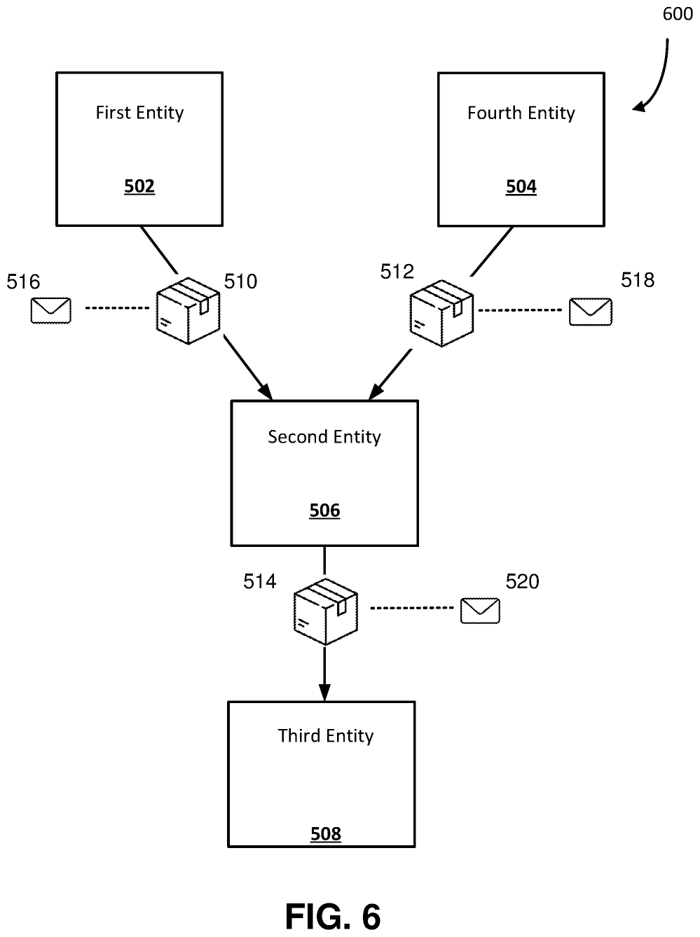

Reference is now made to FIG. 6, which is a second schematic illustration 600 in accordance with embodiments of the present disclosure. The second schematic illustration 600 illustrates the conveyance of first, second, and third items 510, 514, and 512 and the first, second and third transfer request messages 516, 520, and 518 between first, second, third and fourth entities 502, 506, 504, 508.

The second schematic illustration 600 includes the components of the first schematic illustration 500 (FIG. 5). The second schematic illustration 600 further includes an additional production input of the second item 514, i.e., a third item 512. The second schematic illustration includes a fourth entity 504 which may be a supplier of the third item 512 to the second entity 506. As shown, the third item 512 may be conveyed from the fourth entity 504 to the second entity 506. As further shown, a third transfer request message 518 may be associated with the conveyance of the third item 512 from the fourth entity 504 to the second entity 506. The third item 512 may be described with respect to a third quantity. At least a portion of the third item 512 may be an additional production input of the second item 514.

In some embodiments, both at least a portion of the first item 510 and at least a portion of the third item 512 may be production inputs of the second item 514.

As a particular example, the first entity 502 may be a plastic manufacturer and the first item 510 may be a quantity of plastic. The fourth entity 504 may be an ink manufacturer and the third item 512 may be a quantity of ink. The second entity 506 may be a pen manufacturer and the second item 514 may be a quantity of pens. The third entity 508 may be a retailer or a consumer. The first, second and third transfer request messages may be requests for compensation, such as, for example, payment request messages.

The second entity may receive, from the fourth entity, third sustainability data associated with the third item 512 (e.g., the quantity of plastic). The fourth entity may then use the third sustainability to determine a portion of the second item composite sustainability data. In this way, the second item composite sustainability data may include at least a portion of the third sustainability data.

The system may verify the second item composite sustainability data by determining that the second item composite sustainability data includes at least a portion of the third sustainability data.

In some examples, the first resource management system 110 (FIG. 1) may verify the second item composite sustainability data before processing the second transfer request message 520. That is, the second item composite sustainability data may need to be verified as a precondition to receiving a response to the second transfer request message 520. If the second item composite sustainability data is not provided, then the first resource management system 110 (FIG. 1) may prevent a response to the second transfer request message 520. This practice may ensure that the second entity 506 provides second item composite sustainability data that may be verified.

In some embodiments, the system may determine a trust score associated with the second item composite sustainability data. The trust score may be based on the verification of the second item composite sustainability data. In some implementations, the trust score may be expressed, for example, as a percentage. For example, a trust score of 100% may be associated with complete trust, and a trust score of 0% may be associated with a total absence of trust. In some implementations, the trust score may be calculated, for example, on a scale of 1 to 5, or on a scale of 1 to 10, etc. In such implementations, a higher trust score may be associated with a higher degree of trust and a lower trust score may be associated with a lower degree of trust.

Returning again to FIG. 4, after the operation 406, the operation 408 is next.

At the operation 408, the system sends the second transfer request message, the second transfer request message including the second item composite sustainability data.

In some embodiments, the system may provide the second item composite sustainability data to a third-party system 150 (FIG. 1). The third-party system 150 (FIG. 1) may be, for example, an e-commerce provider and/or an enterprise resource planning (ERP) system.

As noted, in some embodiments, the second item 514 (FIG. 5) may be associated with a product identifier, such as a Stock Keeping Unit (SKU), a Universal Product Code (UPC), a European Article Number (EAN), etc. In some such embodiments, the product identifier may be obtained by the system in a manner similar to the manner in which the second item composite accountability data is obtained, i.e., as metadata in the second transfer request message 520 (FIG. 5), in a manner that allows the product identifier to be linked with or associated with the second transfer request message 520 (FIG. 5), and/or as part of a system such as an invoicing system which may then be linked to the second item composite sustainability data.

In some embodiments where the third-party system 150 (FIG. 1) is an e-commerce system, the system may provide, to the e-commerce provider, via an application programming interface (API), the second item composite sustainability data and an indication of an association between the second item composite sustainability data and the product identifier. In this way, the e-commerce provider may then provide the second item sustainability data to customers in connection with the associated product identifier.

In some embodiments, where the third-party system 150 (FIG. 1) is an ERP system, the system may provide, to the ERP system, via an application programming interface (API), the second item composite sustainability data. The system may also provide, to the ERP system, via an application programming interface (API), an indication of an association between the second item composite sustainability data and the product identifier.

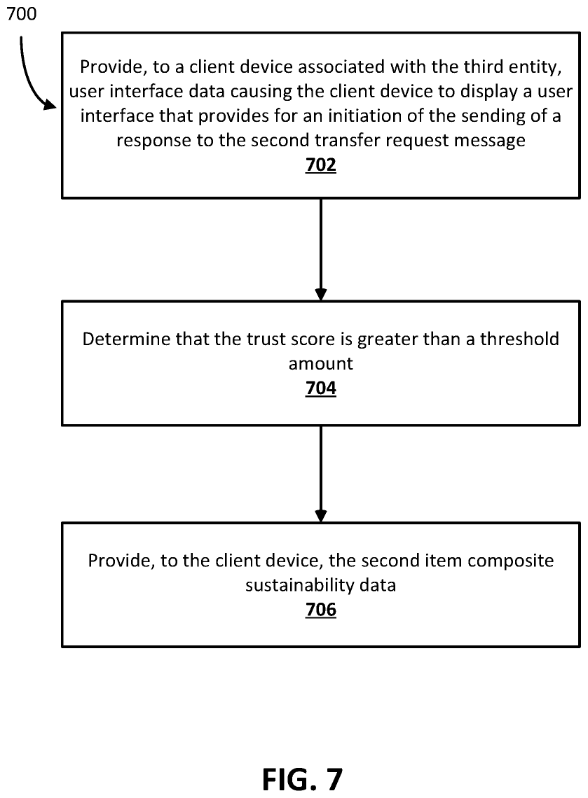

The operation of the first resource management system 110 (FIG. 1) will now be described with reference to the flowchart of FIG. 7 which illustrates a method 700 for providing, to a client device, the second item composite sustainability data, in accordance with embodiments of the present disclosure. Operations 702 and onward are performed by one or more processors of a computing device, such as for example the processor 210 of a suitably configured instance of the example computing device 200, executing software such as, for example, a suitable instance of the application 310.

At the operation 702, the system provides, to a client device associated with the third entity, user interface data causing the client device to display a user interface that provides for an initiation of the sending of a response to the second transfer request message.

At the operation 704, the system determines that the trust score is greater than a threshold amount.

As noted, in some implementations, the trust score may be expressed, for example, as a percentage. In some such implementations, the threshold amount may be, for example, 70% or 80%. In some implementations, the trust score may be calculated, for example, on a scale of 1 to 5, or on a scale of 1 to 10, etc. In such implementations, the threshold amount may be 3 (when the scale is 1 to 5) or 7 (when the scale is 1 to 10), for example. The threshold amount may vary due to the production category of the second item, for example.

At the operation 706, the system provides, to the client device, the second item composite sustainability data. In this way, the second item composite sustainability data may only be provided to the third entity when the trust score is sufficiently high.

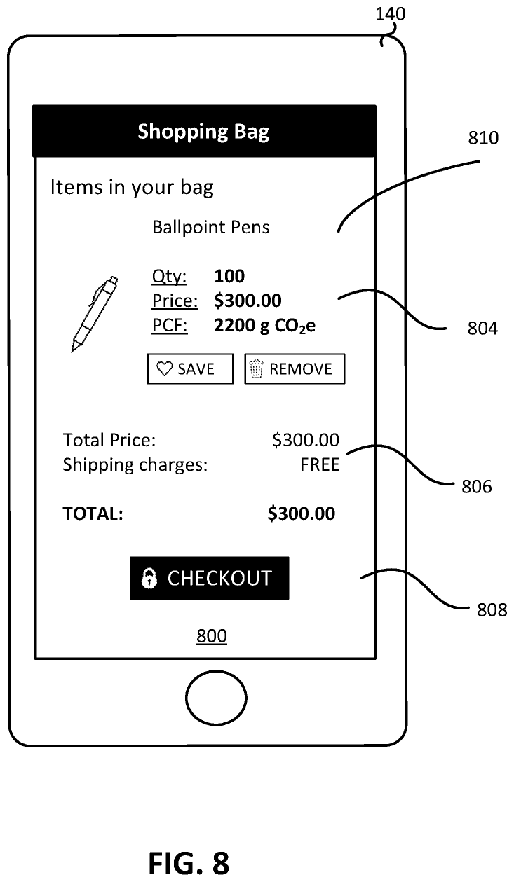

Reference is now made to FIG. 8, which illustrates an example display screen 810 of an example user interface 800 presented on a client device 140, in accordance with embodiments of the present disclosure. The example user interface 800 may provide for an initiation of the sending of a response to the second transfer request message.

As shown, the example user interface 800 displays a title, “Shopping Bag”. The example user interface 800 also displays, in a first area 804, a subtitle “Items in your bag”. The first area 804 further displays an indication that the items are “Ballpoint Pens” at a quantity of 100 and at a price of $300.00. A Product Carbon Footprint (PCF) in connection with the items is listed as “2200 g CO₂e. Options to “SAVE” or “REMOVE” the listed items are also displayed.

The display of the PCF in connection with the items may indicate that sustainability data associated with the items have a trust score that is greater than a threshold amount.

As shown, a second area 806 of the example user interface 800 displays a “Total Price” as “$300.00”, displays “Shipping charges” as “FREE”, and display a “TOTAL” as $300.00. As further shown, a third area 808 of the example user interface 800 displays a virtual button labeled “CHECKOUT”.

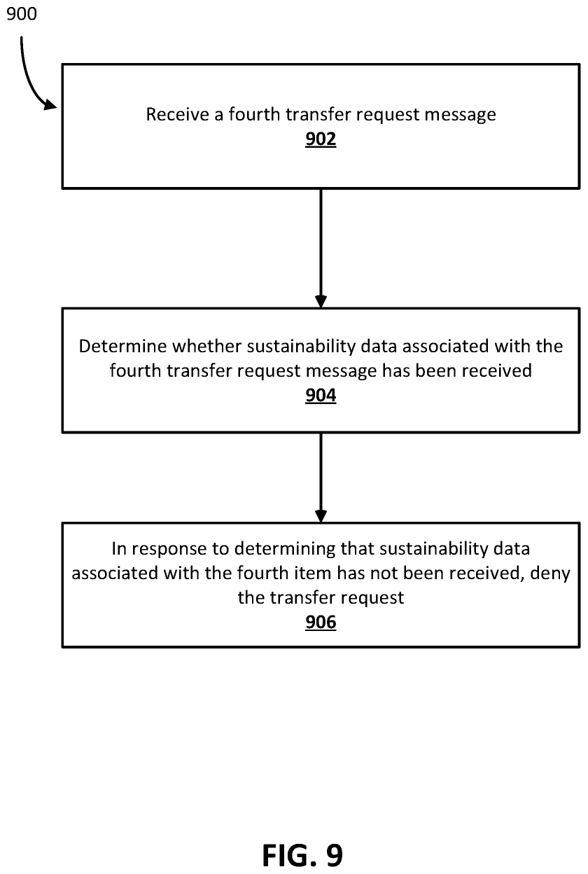

The operation of the first resource management system 110 (FIG. 1) will now be described with reference to the flowchart of FIG. 9 which illustrates a method 900 for denying a transfer request, in accordance with embodiments of the present disclosure. Operations 902 and onward are performed by one or more processors of a computing device, such as for example the processor 210 of a suitably configured instance of the example computing device 200, executing software such as, for example, a suitable instance of the application 310.

At the operation 902, the system receives a fourth transfer message. The fourth transfer message may be associated with a conveyance of a fourth item from a fifth entity to the second entity, the fourth transfer request message including a transfer request.

At the operation 904, the system determines whether sustainability data associated with the fourth item has been received.

At the operation 906, in response to determining that sustainability data associated with the fourth item has not been received, the system denies the service request.

In this way, the system may deny a transfer request when sustainability data associated with the transfer request has not been received.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a processor; and
a memory coupled to the processor and storing instructions that, when executed by the processor, cause the computer system to:
receive a first transfer request message associated with a conveyance of a first item from a first entity to a second entity, the first transfer request message including first sustainability data associated with the first item, the first item being a production input of a second item;
obtain second item composite sustainability data, the second item composite sustainability data to be included in a second transfer request message associated with a conveyance of the second item from the second entity to a third entity;
verify the second item composite sustainability data by determining that the second item composite sustainability data includes at least a portion of the first sustainability data and second item production sustainability data; and
send the second transfer request message, the second transfer request message including the second item composite sustainability data.

2. The computer system of claim 1, wherein prior to sending the second transfer request message, the computer system is further caused to:
determine a trust score associated with the second item composite sustainability data, the trust score being based on the verification of the second item composite sustainability data,
wherein the second transfer request message further includes the trust score.

3. The computer system of claim 2, wherein the computer system is further caused to:
provide, to a client device associated with the third entity, user interface data causing the client device to display a user interface that provides for an initiation of the sending of a response to the second transfer request message;
determine that the trust score is greater than a threshold amount; and
provide, to the client device, the second item composite sustainability data.

4. The computer system of claim 1, wherein the first sustainability data includes a first quantifier associated with the first item, and wherein the second item composite sustainability data includes a second quantifier associated with the second item.

5. The computer system of claim 1, wherein verifying the second item composite sustainability data further causes the system to:
determine a production category associated with the second item; and
verify that the second item composite sustainability data is within a reference range associated with the production category.

6. The of computer system of claim 1, wherein the conveyance of the first item from the first entity to the second entity includes transportation, and wherein verifying the second item composite sustainability data includes determining that the second item composite sustainability data includes transportation sustainability data associated with the transportation.

7. The computer system of claim 1, wherein obtaining the second item composite sustainability data includes providing, to a client device associated with the second entity, user interface data causing the client device to display a user interface that provides for input of the second item composite sustainability data.

8. The computer system of claim 1, wherein the first transfer request message includes first metadata and the second transfer request message includes second metadata, and wherein the first metadata includes the first sustainability data and the second metadata includes the second item composite sustainability data.

9. The computer system of claim 1, wherein prior to verifying the second item composite sustainability data, the computer system is further caused to:
identify a third transfer request message associated with a conveyance of a third item from a fourth entity to the second entity, the third transfer request message including third sustainability data associated with the third item, the third item being a further production input of the second item,
wherein verifying the second item composite sustainability data further includes determining that the second item composite sustainability data includes at least a portion of the third sustainability data.

10. The computer system of claim 1, wherein the computer system is further caused to:
receive a fourth transfer request message associated with a conveyance of a fourth item from a fifth entity to the second entity, the fourth transfer request message including a transfer request;
determine whether sustainability data associated with the fourth item has been received; and
in response to determining that sustainability data associated with the fourth item has not been received, deny the transfer request.

11. The computer system of claim 1, wherein each of the first sustainability data, the second item production sustainability data, and the second item composite sustainability data include environmental, social, and governance (ESG) data.

12. The computer system of claim 11, wherein the ESG data includes carbon footprint data.

13. The computer system of claim 1, wherein the second item is associated with a product identifier, and wherein the computer system is further caused to:
provide, to an e-commerce provider, via an application programming interface (API), the second item composite sustainability data and an indication of an association between the second item composite sustainability data and the product identifier.

14. The computer system of claim 1, wherein the computer system is further caused to:
provide the second item composite sustainability data to an enterprise resource planning (ERP) system.

15. A computer-implemented method comprising:
receiving a first transfer request message associated with a conveyance of a first item from a first entity to a second entity, the first transfer request message including first sustainability data associated with the first item, the first item being a production input of a second item;
obtaining second item composite sustainability data, the second item composite sustainability data to be included in a second transfer request message associated with a conveyance of the second item from the second entity to a third entity;
verifying the second item composite sustainability data by determining that the second item composite sustainability data includes at least a portion of the first sustainability data and second item production sustainability data; and
sending the second transfer request message, the second transfer request message including the second item composite sustainability data.

16. The method of claim 15, wherein prior to sending the second transfer request message, the method further comprises:
determining a trust score associated with the second item composite sustainability data, the trust score being based on the verification of the second item composite sustainability data,
wherein the second transfer request message further includes the trust score.

17. The method of claim 16, wherein the method further comprises:
providing, to a client device associated with a third entity, user interface data causing the client device to display a user interface that provides for an initiation of the sending of a response to the second transfer request message;
determining that the trust score is greater than a threshold amount; and
providing, to the client device, the second item composite sustainability data.

18. The method of claim 15, wherein the first sustainability data includes a first quantifier associated with the first item, and wherein the second item composite sustainability data includes a second quantifier associated with the second item.

19. The method of claim 15, wherein verifying the second item composite sustainability data includes:
determining a production category associated with the second item; and
verifying that the second item composite sustainability data is within a reference range associated with the production category.

20. A non-transitory computer-readable storage medium comprising processor-executable instructions which, when executed, configure a processor to:
receive a first transfer request message associated with a conveyance of a first item from a first entity to a second entity, the first transfer request message including first sustainability data associated with the first item, the first item being a production input of a second item;
obtain second item composite sustainability data, the second item composite sustainability data to be included in a second transfer request message associated with a conveyance of the second item from the second entity to a third entity;
verify the second item composite sustainability data by determining that the second item composite sustainability data includes at least a portion of the first sustainability data and second item production sustainability data; and
send the second transfer request message, the second transfer request message including the second item composite sustainability data.
